(19) United States
(12) Patent Application Publication
(10) Pub. No.: US 2005/0054246 A1
(43) Pub. Date: Mar. 10, 2005

(54) Electrical connector having reliable terminal retaining structure

(76) Inventor: Chi Zhang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/936,274

(22) Filed: Sep. 7, 2004

(30) Foreign Application Priority Data
Sep. 6, 2003 (CN) 03278413.9

(51) Int. Cl. H01R 13/648; G03G 5/00; G03G 15/06; H01R 4/66; H01R 13/40

(52) U.S. Cl. 439/733.1

(57) ABSTRACT

An electrical connector (3) providing an interconnection between two PCBs includes a dielectric housing (1) and a number of terminals (2). The dielectric housing includes a bottom wall (12) parallel to the PCB and a pair of sidewalls (11). A number of grooves (120) and slots (110) respectively defined in the bottom wall and the sidewalls. Each terminal includes a base portion (21), a tail portion (22) protruding outwardly from the dielectric housing, a mating portion (23) extending upwardly from the base portion, and a retaining portion (210) protruding transversely from the base portion and received in the groove. The terminals are retained in the dielectric housing reliably by interferential engagement between the retaining portion and the bottom wall so that a width of the connector is decreased.

### BACKGROUND OF THE INVENTION

1. Field of the Invention

The present invention generally relates to an electrical connector, and more particularly to a board to board electrical connector with an improved terminal retaining structure for reliably positioning terminals therein.

2. Description of Related Art

A conventional electrical connector generally includes a dielectric housing and a plurality of terminals received in the dielectric housing. In order that the terminals can be securely received in the dielectric housing to ensure the electrical signal transmission of the terminals, the electrical connector usually forms a terminal retaining structure for reliably positioning terminals in the dielectric housing.

U.S. Pat. No. 6,338,630 discloses a board to board connector having a plurality of terminals disposed in a dielectric housing thereof. Each terminal has a retaining portion protruding upwardly from a tail portion of the terminal. The retaining portion has protrusions formed at two opposite sides to interferentially engage with a corresponding groove defined in two side walls of the dielectric housing so as to provide enough retention force between the terminals and the dielectric housing. However, the grooves must be defined in the side walls of the dielectric housing for engaging with the retaining portions of the terminals, so it will increase width of the dielectric housing.

Hence, it is desirable to provide an improved electrical connector to overcome the above-mentioned disadvantage of the related art.

### SUMMARY OF THE INVENTION

A main object of the present invention is to provide an electrical connector with a terminal retaining structure for securely positioning terminals therein.

Another object of the present invention is to provide a board to board electrical connector having a small width.

In order to achieve the objects set forth, an electrical connector in accordance with the present invention comprises a dielectric housing, a plurality of conductive terminals received in the dielectric housing. The dielectric housing comprises a bottom wall parallel to the PCB, a pair of sidewalls, a plurality of grooves and slots respectively defined in the bottom wall and the sidewalls. Each terminal includes a base portion, a tail portion extending from the base portion beyond the dielectric housing, a contacting portion extending upwardly from the base portion, and a retaining portion extending transversely from the base portion for engaging with the grooves of the dielectric housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is a cross-sectional view of the electrical connector taken along line 2-2 of FIG. 1, but only one terminal is shown; and

FIG. 3 is a perspective view of a dielectric housing of the electrical connector.

### DETAILED DESCRIPTION OF THE INVENTION

Reference will now be made in detail to the preferred embodiment of the present invention.

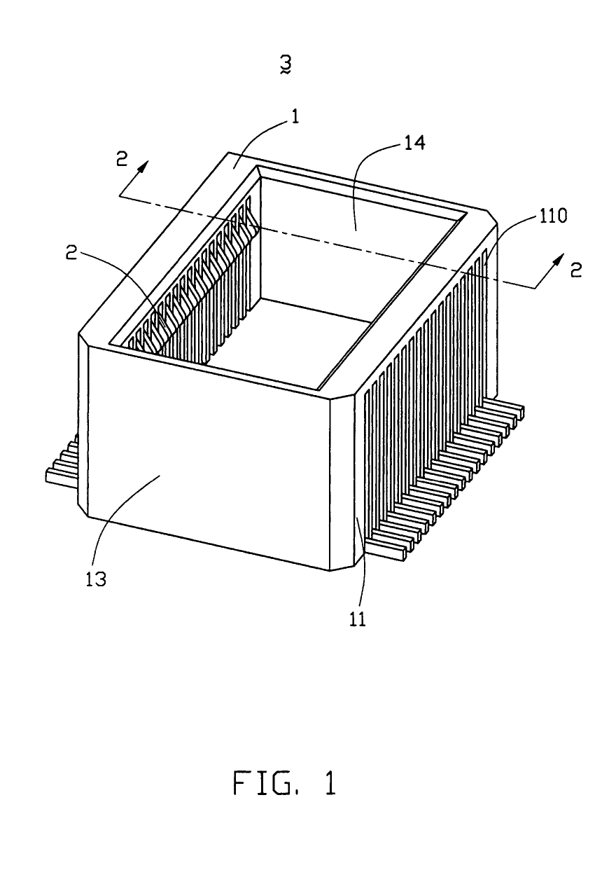

Referring to FIG. 1, an electrical connector 3 in accordance with the present invention is mounted on a printed circuit board (PCB) (not shown) for mating with a complementary connector (not shown) so as to electrically connect two PCBs. The electrical connector 3 comprises a dielectric housing 1 and a plurality of conductive terminals 2 received in the dielectric housing 1. The dielectric housing 1 is elongated and includes a bottom wall 12 parallel to the PCB, a pair of sidewalls 11 projecting from the bottom wall 12 and extending longitudinally, and a pair of end walls 13. The sidewalls 11, the bottom wall 12 and the end walls 13 together define a receiving space 14 for receiving the complementary connector.

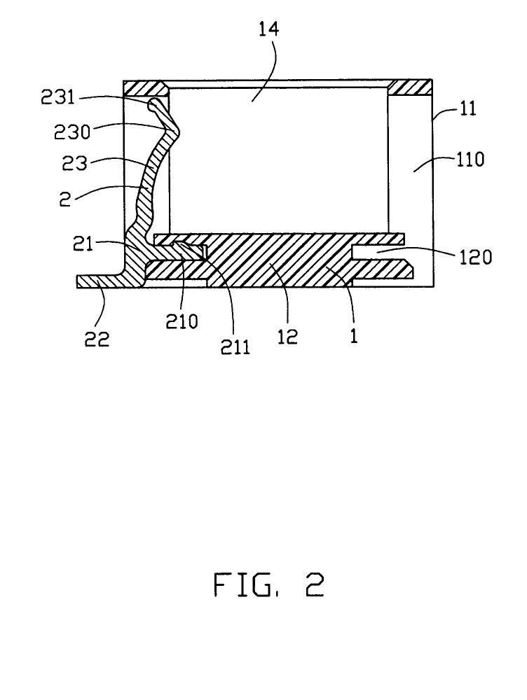

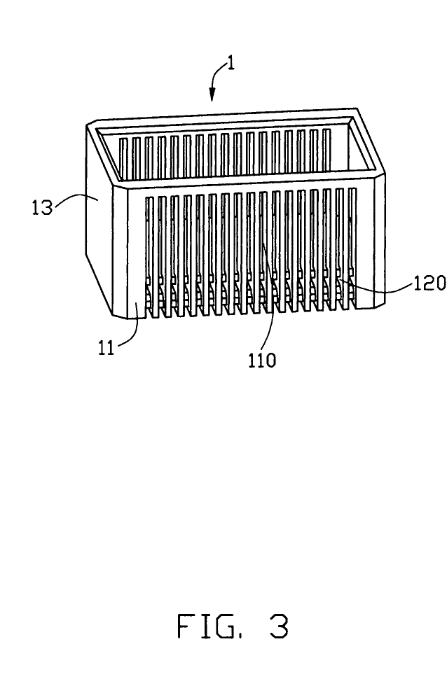

Referring to FIG. 2 and FIG. 3, a plurality of grooves 120 are defined in the bottom wall 12 and extend horizontally. A plurality of slots 110 are defined throughout the sidewalls 11 and communicate with corresponding grooves 120 in the bottom wall 12.

Each terminal 2 includes a base portion 21, a tail portion 22 for being soldered to the PCB and a flexible mating portion 23 extending upwardly from the base portion 21. The base portion 21 is received in the slot 110 of the sidewall 11 and has a retaining portion 210 extending horizontally into the groove 120 of the bottom wall 12. The retaining portion 210 has a bar 211 protruding upwardly therefrom. The mating portion 23 comprises a contacting portion 230 extending into the receiving space 14 for connecting with a mating terminal (not shown) of the complementary connector and a free end 231 extending upwardly and backwardly from the contacting portion 230. The tail portion 22 extends outwardly from a lower side of the base portion 21 along the direction parallel to the bottom wall 12.

In assembly, the terminals 2 are inserted into the dielectric housing 1 from outside of the sidewall 11 with the mating portions 23 and the base portions 21 being received in the corresponding slots 110, and the retaining portions 210 interferentially engaging within the grooves 120 for increasing retention force between the terminals 2 and the dielectric housing 1.

The retaining portions 210 of the terminals 2 engage with the bottom wall 12 of the dielectric housing 1 for reliably retaining terminals 2 therein, thereby decreasing the width of the sidewall 11 of the dielectric housing 1 and further decreasing the total width of the electrical connector 3.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector adapted for being mounted to a printed circuit board (PCB), comprising:
a dielectric housing comprising a bottom wall and a pair of sidewalls projecting from the bottom wall, a plurality of grooves defined in the bottom wall and extending along a first direction, and a plurality of slots defined in the sidewalls and extending along a second direction, the first direction being perpendicular to the second direction;
a plurality of terminals received in the dielectric housing, each terminal comprising a base portion, a tail portion extending outwardly from the dielectric housing, a mating portion extending upwardly from the base portion and a retaining portion extending oppositely to the tail portion from the base portion and interference fitted within a corresponding groove of the dielectric housing.

2. The electrical connector as claimed in claim 1, wherein each slot communicates with a corresponding groove to receive a corresponding terminal.

3. The electrical connector as claimed in claim 1, wherein the dielectric housing comprises two end walls extending from the bottom wall and connecting the sidewalls, said walls defining a receiving space therebetween.

4. The electrical connector as claimed in claim 3, wherein said retaining portion of the terminal has a bar formed thereon.

5. The electrical connector as claimed in claim 4, wherein the mating portion of the terminal comprises a contacting portion extending into the receiving space and a free end extending upwardly and backwardly from the contacting portion.

6. The electrical connector as claimed in claim 5, wherein said base portion and said mating portion are received in the slot of the sidewall.

7. An electrical connector adapted for being mounted to a printed circuit board (PCB), comprising:
a dielectric housing comprising a bottom wall and a pair of sidewalls projecting from the bottom wall, said bottom wall and said sidewalls commonly defining a receiving space therein, a plurality of grooves defined in the bottom wall and extending along a horizontal direction parallel to said bottom wall, and a plurality of slots defined in the sidewalls and extending through the sidewalls in said horizontal direction;
a plurality of terminals assembled, through the respective slots, to the dielectric housing in said horizontal direction and received in the dielectric housing, each of said terminals comprising a base portion, a tail portion extending from the base portion and exposed to an exterior, a mating portion extending upwardly from the base portion and into the receiving space, and a retaining portion extending from the base portion and retainably fitted within the corresponding groove.

8. A method of assembling an electrical connector, comprising steps of:
providing an insulative housing with two opposite sidewalls having a plurality of spaced slots extending therethrough horizontally, a receiving space defined between said two sidewalls;
providing a plurality of terminals each with a base portion, a mating portion and a retention portion extending therefrom; and
assembling said terminals to the housing horizontally under a condition that the retention portion is retained to the housing and the mating portion passes through the corresponding slot and into the receiving space.
